(19) United States
(12) Patent Application Publication
(10) Pub. No.: US 2007/0001993 A1
(43) Pub. Date: Jan. 4, 2007

(54) Plasma display and power module

(76) Inventors: Haruo Koizumi, Kanagawa (JP); Makoto Onozawa, Kanagawa (JP)

Correspondence Address: STAAS & HALSEY LLP, SUITE 700, 1201 NEW YORK AVENUE, N.W., WASHINGTON, DC, 20005, US

(21) Appl. No.: 10/554,098

(22) PCT Filed: Dec. 5, 2003
(86) PCT No.: PCT/JP03/15629

§ 371 Date: Aug. 18, 2006

(30) Foreign Application Priority Data
Apr. 22, 2003 (JP) 2003-117082

(51) Int. Cl. G09G 3/36

(52) U.S. Cl. 345/101

(57) ABSTRACT

A plasma display device has a power module having a plurality of power devices, and temperature detecting means installed in the power module. The power module drives a plasma display panel in accordance with a signal from input signal control means, and has a plurality of power devices for generating a drive signal for the plasma display panel, and temperature detecting means for detecting the temperature of the power module. The temperature of the power module is controlled by feeding temperature information detected by the temperature detecting means back to the input signal control means.

### TECHNICAL FIELD

The present invention relates to a plasma display device and a power module, and more particularly to a power module which integrates output transistors for driving a plasma display panel (PDP), and a plasma display device comprising this power module.

### BACKGROUND ART

With the recent increase in the size of display devices, demands are being made for a decrease in the thickness of display devices, and various types of flat display devices have been proposed. For example, a matrix panel which displays a digital signal as is, or in other words a gas-discharge panel such as a PDP, and matrix panels such as a DMD (Digital Micromirror Device), an EL display element, a fluorescent display tube, and a liquid crystal display element have been proposed. Of these flat display devices, the gas-discharge panel has entered into practical use as a display device for a large-screen, direct view HDTV (high definition television) for reasons such as: manufacturing is simple, and therefore the screen can be enlarged easily; the gas-discharge panel is self-luminous, and therefore the display quality is high; and the response speed is high.

In a plasma display device, each field (frame) has a plurality of light-emitting blocks (subfields: SF) constituted by a plurality of sustain discharge pulses, and halftones are displayed in accordance with the combination of subfields. The power consumption of the plasma display device depends on the number of light-emitting pulses (sustain discharge pulses, or sustain pulses) contributing to the light emission, and in recent years, applying a power module which integrates power devices for controlling the sustain pulses to the plasma display device has been considered. Accordingly, it has become desirable to provide a power module in which thermal stress can be reduced, enabling an increase in reliability, and a plasma display device comprising such a power module.

Note that a conventional plasma display device and power module, as well as the problems thereof, will be described in detail below with reference to the drawings.

### DISCLOSURE OF THE INVENTION

An object of the present invention is to provide a plasma display device which is capable of reducing thermal stress in a power module, which is a problem encountered during use of the power module, and thereby extending the life of the power module and reducing power consumption. A further object of the present invention is to provide a power module in which thermal stress can be reduced, enabling an improvement in reliability.

A first aspect of the present invention provides a plasma display device comprising a power module having a plurality of power devices, and temperature detecting means installed in the power module. The temperature of the power module is controlled by feeding temperature information detected by the temperature detecting means back to input signal control means.

A second aspect of the present invention provides a power module for driving a plasma display panel in accordance with a signal from input signal control means, comprising a plurality of power devices for generating a drive signal for the plasma display panel, and temperature detecting means for detecting the temperature of the power module. The temperature of the power module is controlled by feeding temperature information detected by the temperature detecting means back to the input signal control means.

According to the plasma display device of the present invention, thermal stress in the power module, which is a problem encountered during use of the power module, is reduced, and hence the life of the power module can be increased and power consumption can be reduced. According to the power module of the present invention, thermal stress can be reduced, enabling an improvement in reliability.

### BRIEF DESCRIPTION OF THE DRAWINGS

The present invention will be described below with reference to the attached drawings, in which:

FIG. 1 is a block diagram showing an example of a conventional plasma display device;

FIG. 2 is a schematic diagram showing a heat deterioration characteristic (the life of an element) based on Arrhenius' equation;

FIG. 3 is a view showing the disposal of a power device and a thermal detection element serving as background art;

FIG. 4 is a sectional view showing an embodiment of a power module according to the present invention;

FIG. 5 is a block circuit diagram showing an outline of the main parts in an embodiment of a plasma display device according to the present invention;

FIG. 6 is a view showing an example of a power module and a temperature detection circuit in the main parts of the plasma display device shown in FIG. 5;

FIG. 7 is a view showing the relationship between the temperature of the power module that is applied to the plasma display device of the present invention, and the number of sustain pulses;

FIG. 8 is a flowchart illustrating an example of temperature control processing for controlling the temperature of the power module in the plasma display device of the present invention;

FIG. 9 is a view showing an example of the disposal of power modules in the plasma display device of the present invention;

FIG. 10 is a block circuit diagram showing an outline of the main parts in another embodiment of the plasma display device according to the present invention; and

FIG. 11 is a view illustrating an example of power reduction processing in the plasma display device according to the present invention.

### BEST MODES FOR CARRYING OUT THE INVENTION

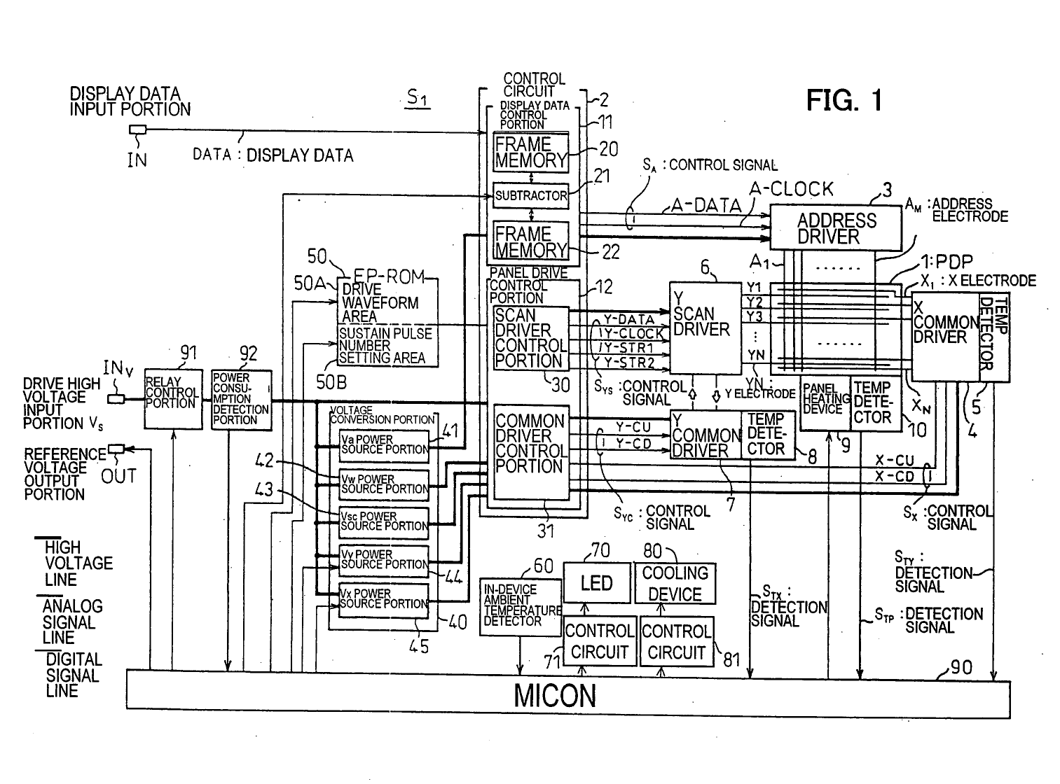

Before describing embodiments of the plasma display device and power module according to the present invention, a conventional plasma display device and a conventional power module of the background art, and the problems related thereto, will be described in detail with reference to the attached drawings (FIGS. 1 to 3).

A plasma display device which detects the temperature of a PDP and each driver in order to compensate the display characteristic and prevent heating has been proposed in the prior art (see Japanese Unexamined Patent Application Publication H9-006283, for example).

FIG. 1 is a block diagram showing an example of a conventional plasma display device, which is an example of the plasma display device disclosed in the above Japanese Unexamined Patent Application Publication H9-006283.

As shown in FIG. 1, a conventional plasma display device S₁ comprises a PDP (plasma display panel) 1, an address driver 3 which applies an address pulse and a write pulse to address electrodes A₁ to AM on the basis of a control signal SA from a control circuit 2, an X common driver 4 which applies a write pulse and a sustain pulse to X electrodes X₁ to X_{N} on the basis of a control signal S_{X} from the control circuit 2, a temperature detector 5 which detects the temperature of the X common driver 4 and outputs a detection signal, a Y scan driver 6 which applies a scan pulse to Y electrodes Y₁ to Y_{N} on the basis of a control signal S_{YS} from the control circuit 2, and a Y common driver 7 which applies a sustain pulse to the Y electrodes Y₁ to Y_{N} via the Y scan driver 6, on the basis of a control signal S_{YC} from the control circuit 2.

The plasma display device S₁ further comprises a temperature detector 8 which detects the temperature of the Y common driver 7 and outputs a detection signal S_{TY}, a panel heating device 9which heats the PDP 1, a temperature detector 10 which detects the temperature of the PDP 1 and outputs a detection signal S_{TP}, the control circuit 2, which controls driving of the PDP 1 on the basis of a predetermined signal (a dot clock CLK, display data DATA, a vertical synchronizing signal VSYNC, a horizontal synchronizing signal HSYNC, and so on) and control of a micro-computer 90, a voltage conversion portion 40 which converts a high voltage input from a drive high-voltage input portion IN_{V} into a voltage for each of the pulses applied to the PDP 1, and an EPROM (Erasable and Programmable Read Only Memory) 50 having a drive waveform area 50A, which stores the waveform of each of the pulses applied to the PDP 1 in advance and outputs the waveform of the desired pulse, and a sustain pulse number setting area 50B.

The plasma display device S, further comprises an in-device ambient temperature detector 60 which detects the interior temperature of the device, a control circuit 71 which controls the display of an LED 70 for issuing warnings, a control circuit 81 which controls the operation of an air cooling device 80, a relay control portion 91 which prohibits the application of high voltage to the voltage conversion portion 40 and control circuit 2, a power consumption detector 92 which detects the power consumption of the entire device, and the micro-computer 90 which controls each portion of the plasma display device. Note that in this constitution, high voltage power for driving each driver is applied to each driver together with the control signals S_{A}, S_{Y}, S_{YC}, and S_{X}. Further, the display data DATA are input from the outside through a display data input portion IN.

The control circuit 2 comprises a display data control portion 11 which time-divides data corresponding to a single frame (field) of the display data DATA into a plurality of subfield data in accordance with control of the dot clock CLK, display data DATA, and micro-computer 90, and outputs the control signal S_{A} based on these subfield data, and a panel drive control portion 12 which outputs the control signals S_{X}, S_{YS}, and S_{YC} in accordance with control of the vertical synchronizing signal VSYNC, horizontal synchronizing signal HSYNC, and the micro-computer 90. Here, the display data control portion 11 and panel drive control portion 12 exchange data required by each other.

The display data control portion 11 comprises frame memories 20, 22 which temporarily store the input display data DATA frame by frame, and a subtractor 21 which is controlled by the micro-computer 90 to correct the number of gray levels in the display data DATA.

The panel drive control portion 12 comprises a scan driver control portion 30 which outputs the control signal S_{YS} on the basis of a scan pulse P_{AY} included in the subfield data that are corrected by the display data control portion 11, the vertical synchronizing signal VSYNC, and the horizontal synchronizing signal HSYNC, and a shared driver control portion 31 which outputs the control signals S_{YC} and S_{X} on the basis of the number of sustain pulses P_{XS} and P_{YS} included in the subfield data that are corrected by the display data control portion 11, the vertical synchronizing signal VSYNC, and the horizontal synchronizing signal HSYNC.

The voltage conversion portion 40 comprises a Vₐ power source portion 41 which generates a high voltage that is applied to the address electrodes A₁ to A_{M} in order to generate a write pulse P_{AW} and an address pulse P_{AA}, on the basis of a high voltage that is applied from an external high voltage generating device (not shown) via the drive high pressure input portion IN_{V}, a V_{W} power source portion 42 which generates a high voltage that is applied to the X electrodes X₁ to X_{N} in order to generate a write pulse P_{XW}, a V_{SC} power source portion 43 which generates a high voltage that is applied to the Y electrodes Y₁ to Y_{N} for the purpose of a main address discharge (wall charge storage discharge) during an address period, a V_{y} power source portion 44 which generates a high voltage that is applied to the Y electrodes Y₁ to Y_{N} in order to generate the scan pulse P_{AY} during the address period, and a V_{X} power source portion 45 which generates high voltage power (an X address voltage V_{X}) that is applied to the X electrodes X₁ to X_{N} for the purpose of the main address discharge (wall charge storage discharge) during the address period.

The micro-computer 90 is connected to a reference voltage output portion OUT for a sustain discharge voltage (sustain pulse voltage), and thus controls the external high voltage generating device (not shown) for generating the sustain discharge voltage, whereby the drive high voltage applied from the drive high voltage input portion IN_{V} is controlled and the sustain discharge voltage is controlled.

Further, a power electronic circuit device which is capable of realizing an increase in output current without lowering the safety and increasing the structural complexity of a semiconductor switching element used in a motor control inverter circuit or the like has been proposed in the background art (see Japanese Unexamined Patent Application Publication H11-262241, for example) Japanese Unexamined Patent Application Publication H11-262241 discloses an IGBT module having a power device (IGBT: Insulated Gate Bipolar Transistor) and a temperature sensor, and describes a three-phase inverter circuit installed with six temperature sensors. Moreover, Japanese Unexamined Patent Application Publication H11-262241 discloses a power electronic circuit device which is designed to perform current limitation by controlling the rotation speed of a compressor (air-conditioning motor) to ensure that an element-vicinity temperature, detected by a temperature sensor provided in the vicinity of an IGBT chip, and a junction temperature, estimated on the basis of the average output current of the three-phase inverter circuit, do not exceed a maximum allowable temperature.

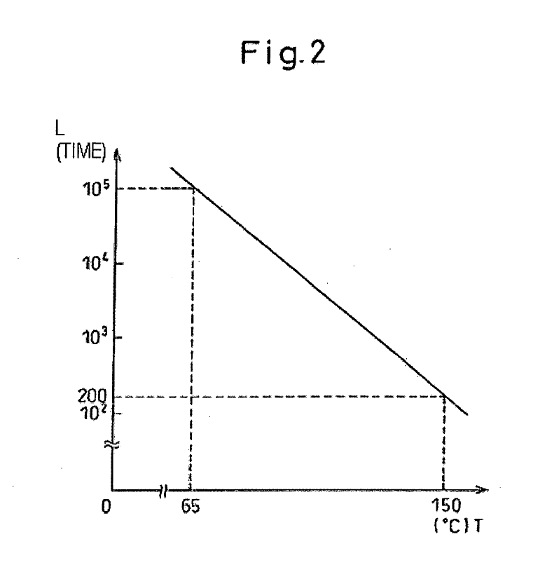

FIG. 2 is a schematic diagram showing a heat deterioration characteristic (element life) based on Arrhenius' equation, and refers, for example, to the life (the threshold value of allowable characteristic change) of a power device.

As shown in FIG. 2, the life of a power device (for example, a power MOSFET, IGBT, power diode, or similar) is approximately 10⁵ hours when the temperature of the power device (the environmental temperature in which the power device is used) is 65° C., for example, but falls to approximately 200 hours when the temperature reaches 150° C., and hence it is known that the life of a power device decreases logarithmically in relation to increases in temperature.

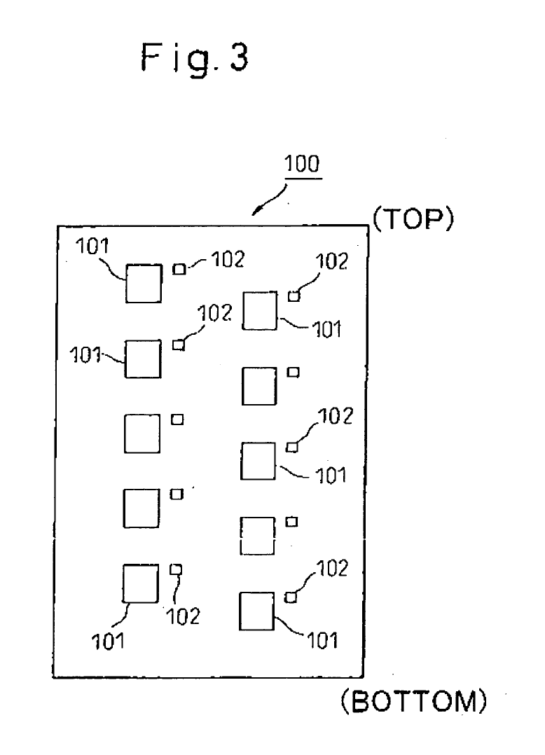

FIG. 3 is a view showing the disposal of a power device and a heat detection element serving as background art. In FIG. 3, the reference numeral 100 denotes a power device unit, 101 denotes a power device, and 102 denotes a temperature detection element. Here, for example, the power device 101 is used in a plasma display device for performing a sustain discharge of a PDP. The power device unit 100 comprising a plurality of the power devices 101 is typically disposed in a perpendicular direction to the ground.

As shown in FIG. 3, in the plasma display device of the background art, the plurality of power devices 101 are arranged at predetermined intervals on the power device unit 100, and the temperature detection elements 102 are provided respectively in the vicinity of each power device 101. Here, the power device 101 is an output driver FET or a power driver FET, and accordingly, the temperature detection element 102 is an output driver temperature detection element or a power driver temperature detection element.

As described above, a device which detects the temperature of the PDP and each driver to compensate the display characteristic and prevent heating has been proposed in the prior art as a plasma display device. However, in this plasma display device, for example, the power device 101 used to perform the sustain discharge is not modularized, and instead it has been proposed that the plurality of power devices 101 be mounted directly on a radiator, and that the temperature of the power device 101 be detected by the temperature detection element 102 provided in the vicinity of each power device 101.

The plasma display device disclosed in the aforementioned Japanese Unexamined Patent Application Publication H9-006283 compensates the display characteristic and prevents heating by detecting the temperature of the PDP and drivers, but does not achieve an increase in the life of a power module integrating a plurality of power devices, and a reduction in power consumption.

Further, the aforementioned Japanese Unexamined Patent Application Publication H11-262241 discloses a power electronic circuit device in which a power module is constituted by fixing to a metal block a semiconductor chip formed with a power interrupting semiconductor switching element used in a motor control inverter circuit or the like, and which limits the current of the semiconductor switching element on the basis of the element-vicinity temperature, detected by a temperature sensor provided in the vicinity of the semiconductor chip, and a quantity of state relating to the current of the semiconductor switching element. However, the power electronic circuit device of Japanese Unexamined Patent Application Publication H11-262241 is fundamentally different to a device for controlling a power module which integrates power devices in a plasma display device for performing display by means of a sustain discharge. Furthermore, the power electronic circuit device of Japanese Unexamined Patent Application Publication H11-262241 achieves an increase in the output current without lowering the element safety and increasing the structural complexity of the device, but does not achieve an increase in the life of a power module which integrates a plurality of power devices and a reduction in power consumption in a plasma display device.

Hence in a conventional plasma display device, for example, it is necessary to design the radiator of a power device used to perform a sustain discharge in consideration of the heat that is generated when the number of PDP sustain pulses is greatest, even in the case of a plasma display device for performing specific display which has a low display frequency. Moreover, in a conventional plasma display device, a power module which integrates a plurality of power devices is not used, and hence an increase in the life of the power module and a reduction in power consumption are not achieved.

Embodiments of the plasma display device and power module according to the present invention will now be described in detail with reference to the attached drawings.

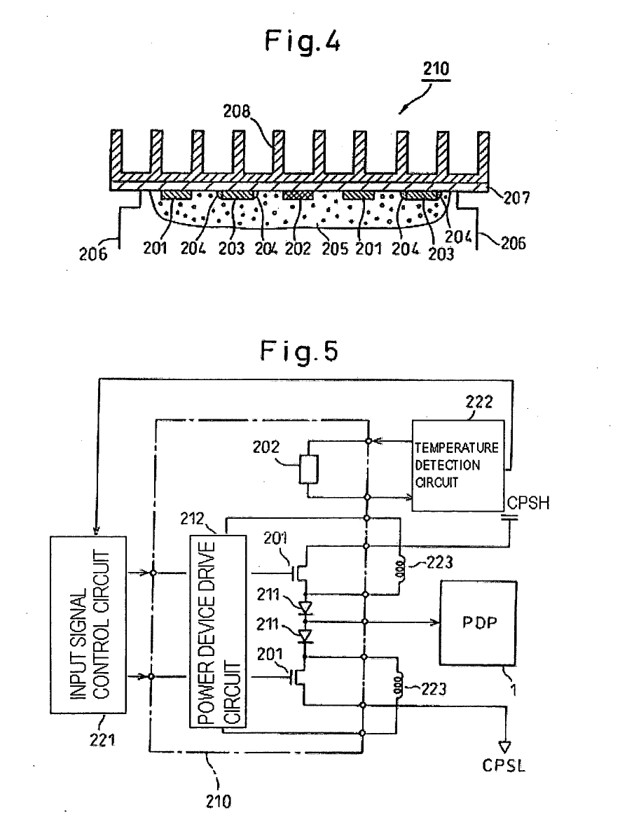

FIG. 4 is a sectional view showing an embodiment of the power module according to the present invention. In FIG. 4, the reference numeral 210 denotes a power module, 201 denotes a power device, 202 denotes a heat detection element, 203 denotes a ceramic element, 204 denotes a solder fillet, 205 denotes a mold sealing resin, 206 denotes an input/output terminal, 207 denotes a substrate, and 208 denotes a radiator.

As shown in FIG. 4, the power device 201, heat detection element 202, ceramic element 203, and so on are disposed on the substrate 207. Here, the power device 201 is an element such as an IGBT, a power FET, or another power transistor, or a power diode, for example, and is used to perform a sustain discharge on the plasma display panel in the plasma display device, for example. The ceramic element 203 is a ceramic chip component constituting a resistance or condenser, for example, and is connected to a printed circuit on the substrate 207 by the solder fillets 204. Note that the substrate 207 is a metallic substrate made of aluminum, copper, or the like, or a ceramic substrate made of alumina or the like, for example, and thus serves to convey the heat generated by the power device 201 to the radiator 208 effectively. When the substrate 207 is a metallic substrate, the printed circuit is provided thereon via an insulator layer.

The power module 210 is constituted such that the power device 201, ceramic element 203, heat detecting element 202, and so on disposed on (wired to) the substrate 207 are sealed by the mold sealing resin 205. Here, as shown in FIG. 4, the radiator 208 for performing thermal diffusion is mounted on the substrate 207, but the radiator 208 may be omitted. Further, the heat detecting element 202 is disposed in the vicinity of the power device 201 serving as a heat-generating element, for example, and hence a thermistor, diode, or thermo-electric couple may be applied as the heat detecting element 202. Note that a predetermined number of the input/output terminals 206 is disposed on the periphery of the mold sealing resin 205, for example.

FIG. 5 is a block circuit diagram showing an outline of the main parts in an embodiment of the plasma display device according to the present invention. In FIG. 5, the reference numeral 211 denotes a diode, 212 denotes a power device drive circuit, 221 denotes an input signal control circuit, 222 denotes a temperature detection circuit, 223 denotes a coil, and 1 denotes the PDP. Here, the input signal control circuit 221 corresponds to the control circuit 2 (common driver control portion 31) and the micro-computer 90 of the plasma display device in FIG. 1. Further, the power module 210 of this embodiment corresponds to the X common driver 4 and Y common driver 7 of the plasma display device in FIG. 1.

As shown in FIG. 5, the power module 210 of this embodiment is installed with the heat detection element 202, such as a thermistor, a diode, or a thermo-electric couple. Temperature information detected by the heat detection element 202 (for example, resistance value change produced by a thermistor, V_{F} change produced by a diode, or electromotive force change produced by a thermo-electric couple) is detected by the temperature detection circuit 222 provided on the exterior of the power module 210, the power module temperature information is fed back to the input signal control circuit 221 (the micro-computer 90 of FIG. 1), and thus the temperature of the power module 210 is controlled.

Specifically, for example, when the temperature of the power module 210 reaches or exceeds a predetermined value (a solder surface prescribed temperature value Tₒ, for example), the output of the power module 210 is blocked.

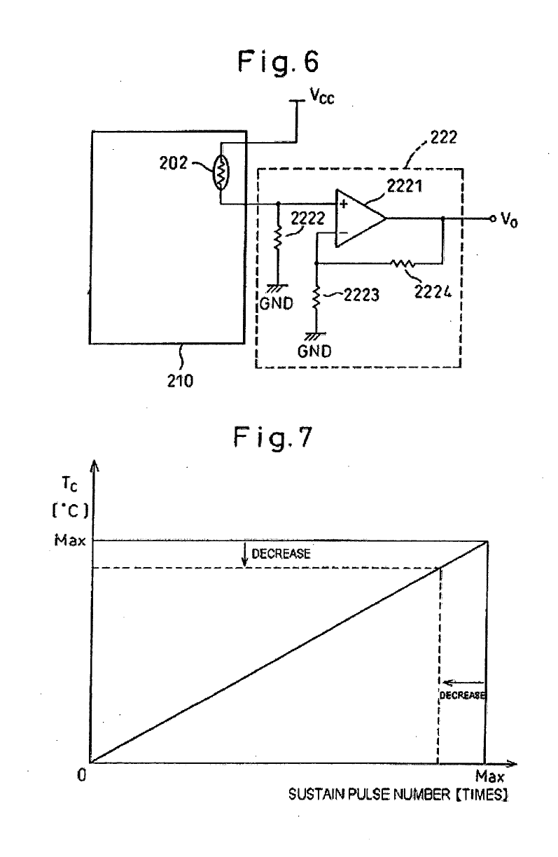

FIG. 6 is a view showing an example of the power module and temperature detection circuit in the main parts of the plasma display device shown in FIG. 5. In FIG. 6, a thermistor is used as the temperature detection element 202.

The temperature detection circuit 222 is provided on the exterior of the power module 210, and comprises an operational amplifier circuit (op-amp) 2221, and resistances 2222 to 2224. One end of the thermistor 202 is connected to a reference potential power wire Vcc, and the other end is connected to the positive input terminal of the operational amplifier circuit 2221 and via the resistance 2222 to a low potential power line (GND). Note that the output of the operational amplifier circuit 2221 is fedback to the negative input terminal of the operational amplifier circuit via the resistance 2224, and connected to the low potential power line (GND) via the resistance 2223.

With the thermistor 202 and temperature detection circuit 222 (temperature detecting means) shown in FIG. 6, the resistance value of the thermistor 202, which corresponds to the temperature of the power module 210, is detected by the temperature detection circuit 222, and an output voltage Vₒ of the temperature detection circuit 222 (the output of the operational amplifier circuit 2221) is fed back to the input signal control circuit 221 (micro-computer 90). Here, the constitution of the temperature detection circuit 222 is merely one example thereof, and various circuit constitutions may be applied. Moreover, the temperature detection element 202 may be a diode, thermo-electric couple, or similar device rather than a thermistor, and the constitution of the temperature detection circuit 222 is modified in various ways in accordance with the applied temperature detection element.

FIG. 7 is a view showing the relationship between a temperature (temperature increase saturation temperature) Tc of the power module applied to the power display device of the present invention, and the number of sustain pulses (the number of PDP sustain pulses).

As is shown clearly in FIG. 7, the temperature increase saturation temperature Tc of the power module 210 can be reduced by lowering the number of sustain pulses in the sustain discharge of the PDP 1. In other words, the temperature of the power module 210 can be controlled by the PDP sustain pulse number.

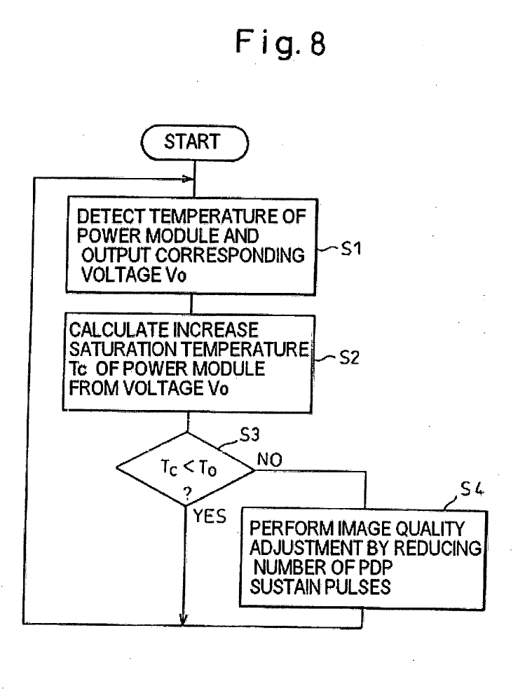

FIG. 8 is a flowchart illustrating an example of processing for controlling the temperature of the power module in the plasma display device of the present invention, and hence illustrating the power module temperature control processing that is performed by the thermistor 202 and temperature detection circuit 222 shown in FIG. 6.

When the power module temperature control processing begins, first, in a step S1, the temperature of the power module 210 is converted into the corresponding output voltage Vₒ by the power module 210 and temperature detection circuit 222 described above. The process then advances to a step S2, where the temperature increase saturation temperature T_{c} of the power module 210 is calculated from the voltage Vₒ in the input signal control circuit 221 (micro-computer 90). Here, calculation (conversion) of the temperature increase saturation temperature T_{c} of the power module from the voltage Vₒ is performed by converting the voltage Vₒ (the output of the temperature detecting means (temperature information)) into the temperature increase saturation temperature T_{c} of the power module using a conversion table stored in a storage device in advance, or by calculating the temperature increase saturation temperature T_{c} of the power module using a coefficient stored in the storage device in advance, for example. Note that semiconductor memory such as a PROM (Programmable Read Only Memory), for example, may be used as the storage device.

Next, in a step S3, the calculated temperature increase saturation temperature T_{c} of the power module is compared with the predetermined solder surface prescribed temperature value Tₒ to determine whether or not the former is lower than the latter. If it is determined in the step S3 that the temperature increase saturation temperature T_{c} of the power module 210 is lower than the solder surface prescribed temperature value Tₒ (T_{c}<Tₒ), the process returns to the step S1, and the same processing is repeated. If, on the other hand, it is determined in the step S3 that the temperature increase saturation temperature T_{c} of the power module 210 is equal to or greater than the solder surface prescribed temperature value Tₒ (T_{c}>Tₒ), the process advances to a step S4, where image quality adjustment is performed by reducing the number of sustain pulses of the PDP 1. More specifically, by reducing the number of sustain pulses, the amount of heat generated by the power devices is reduced, thereby lowering the temperature of the power module 210 and thus adjusting the image quality of the displayed image. The process then returns to the step S1.

In the process described above, the temperature of the power module 210 is lowered by reducing the number of sustain pulses of the PDP 1, but control to lower the temperature of the power module 210 can also be performed by reducing the voltage level of the sustain discharge of the PDP 1, or reducing the magnitude of the power source current used in the sustain discharge, for example.

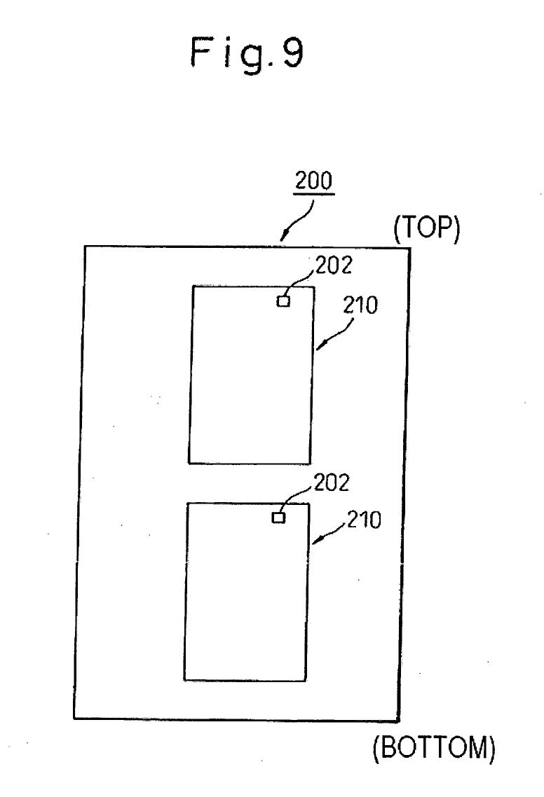

FIG. 9 is a view showing an example of the disposal of the power modules in the plasma display device of the present invention. In FIG. 9, the reference numeral 200 denotes a power device unit. The power device unit 200 shown in FIG. 9 comprises two power modules 210, 210, but may comprise more power modules.

As shown in FIG. 9, for example, in the plasma display device, the power device unit 200 is typically disposed in a perpendicular direction to the ground, and the temperature detection element 202 is disposed in the upper portion of each power module 210. Here, the power device unit 200 may comprise only one power module 210.

Note that when the power device unit 200 comprises a plurality of the power modules 210, 210, . . . , the temperature detection element 202 may be disposed in the upper portion of only the power module provided in the uppermost position. It is believed that the temperature of the power module disposed in the uppermost position rises by the greatest extent due to heat convection, and hence by detecting the temperature of the power module disposed in the uppermost position, all of the power modules can be controlled. Furthermore, by reducing the number of temperature detecting means (the temperature detection element, temperature detection circuit, and so on), the control operation can be simplified.

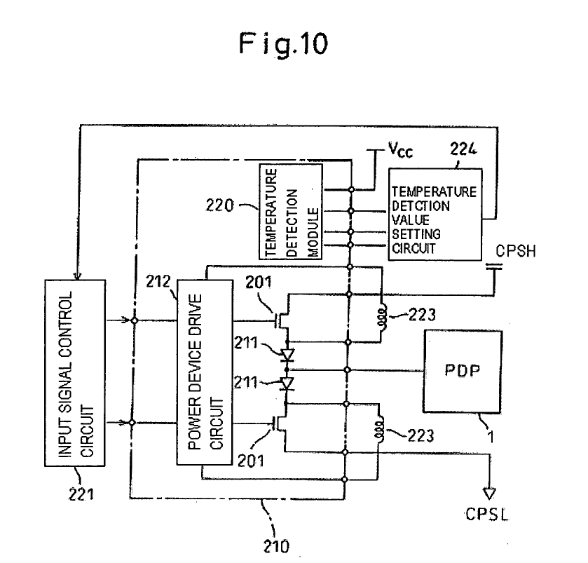

FIG. 10 is a block circuit diagram showing an outline of the main parts in another embodiment of the plasma display device according to the present invention. In FIG. 10, the reference numeral 220 denotes a temperature detection module, and 224 denotes a temperature detection value setting circuit.

As can be seen clearly from a comparison of FIGS. 5 and 10, in the plasma display device of this embodiment, the power module 210 is installed with the temperature detection module 220 instead of the temperature detection element 202, and the output of the temperature detection module 220 is fed back to the input signal control circuit 221 (micon 90) via the temperature detection value setting circuit 224, which is provided on the exterior of the power module 210. Note that the temperature detection value setting circuit 224 may be omitted depending on the functions of the temperature detection module 220.

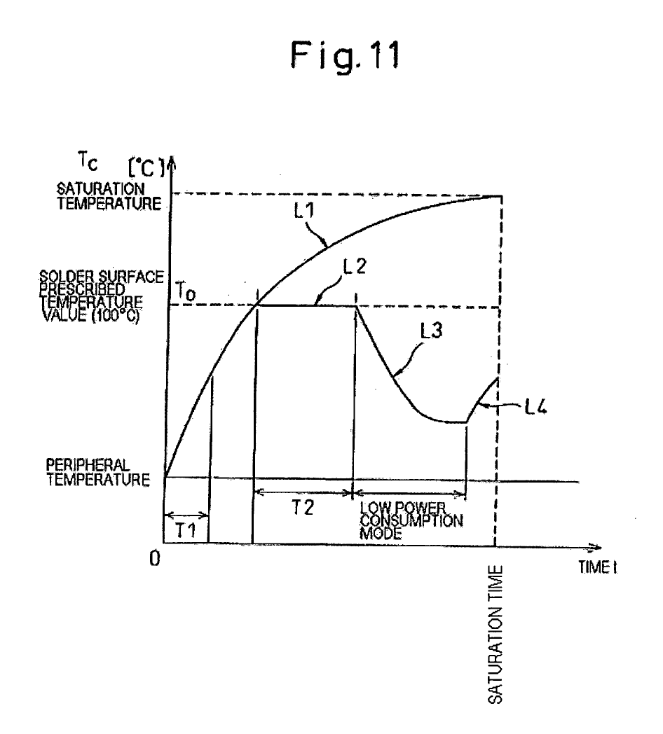

FIG. 11 is a view illustrating an example of power reduction processing in the plasma display device according to the present invention. In FIG. 11, the ordinate indicates the temperature increase saturation temperature T_{c}, and the abscissa indicates the time t. Further, the reference symbol L1 denotes a temperature curve when power reduction processing is not performed, and the reference symbols L2 to L4 denote a temperature curve when the power reduction processing of this embodiment is applied.

First, in a case where full-screen black is displayed on the PDP 1 and power reduction processing is not performed, approximately 80 W of power, for example, are consumed when full-screen black display is applied to the PDP 1, and the temperature increase saturation temperature T_{c} of the power module increases over time, exceeding the solder surface prescribed temperature value Tₒ and rising toward the saturation temperature as shown by the curve L1 in FIG. 11.

On the other hand, when the temperature of the power module 210 (the temperature increase saturation temperature T_{c} of the power module) rises beyond the solder surface prescribed temperature value Tₒ during application of the power reduction processing of this embodiment, control is performed to hold the temperature of the power module 210 at a fixed level, as shown by the curve L2 in FIG. 11, and when this condition remains unchanged for a predetermined time period (control setting time period) T2, as shown by the curve L2, the output of the power module 210 is blocked, thereby entering a low power consumption mode. As a result, the temperature (T_{c}) of the power module 210 decreases over time, as show by the curve L3. In this low power consumption mode, the approximately 80 W of power consumed during full-screen black display are reduced to approximately 1 W, for example. After the low power consumption mode has been applied continuously for a predetermined time period, or after the temperature (T_{c}) of the power module has decreased to a predetermined temperature, it is possible to switch back to normal display mode.

Hence in this embodiment, the temperature information that is detected by the temperature detecting means (temperature detection element 202) installed in the power module 210 is fed back to the input signal control circuit 221 (micro-computer 90), and when the temperature (T_{c}) of the power module 210 increases beyond a predetermined value (the solder surface prescribed temperature value Tₒ), the temperature T_{c} of the power module is controlled to a fixed level (Tₒ). Moreover, when this condition remains unchanged for the predetermined time period (T2), control is performed to block the output of the power module 210 and enter into the low power consumption mode (L3). In so doing, breakage of the power devices can be avoided, and power consumption can be reduced.

According to each embodiment of the present invention, breakage of the power devices can be avoided during abnormal heat generation, and by performing serial temperature monitoring, appropriate control can be applied in accordance with the temperature. Further, according to each embodiment of the present invention, thermal stress can be reduced, enabling an increase in the life of the power module, and as a result, the reliability of the plasma display device can be improved.

According to the present invention as described above, it is possible to provide a plasma display device which is capable of reducing thermal stress in a power module, which is a problem encountered during use of the power module, and thereby extending the life of the power module and reducing power consumption. Also according to the present invention, it is possible to provide a power module in which thermal stress can be reduced, enabling an improvement in reliability.

1. A plasma display device comprising:
a power module which has a plurality of power devices; and
temperature detecting unit installed in said power module,
wherein the temperature of said power module is controlled by feeding temperature information detected by said temperature detecting unit back to input signal control unit.

2. The plasma display device according to claim 1, wherein when the temperature of said power module reaches or exceeds a predetermined value, the output of said power module is blocked.

3. The plasma display device according to claim 1, wherein when the temperature of said power module rises above a predetermined value, control is performed to hold the temperature of said power module at a fixed value, and when this condition remains unchanged for a predetermined time period, the output of said power module is blocked, thereby entering a low power consumption mode.

4. The plasma display device according to claim 1, wherein said power module is used to perform a sustain discharge on a plasma display panel.

5. The plasma display device according to claim 1, wherein when said power module is used to display an image, said temperature information is converted into a temperature increase saturation temperature of said power module using a conversion table stored in advance in a storage device, and said converted temperature increase saturation temperature of said power module is compared with a predetermined temperature,
whereby, when said temperature increase saturation temperature of said power module is lower than said predetermined temperature, the temperature of said power module is detected by said temperature detecting unit, and
when said temperature increase saturation temperature of said power module is equal to or greater than said predetermined temperature, image quality adjustment is performed by reducing a number of sustain pulses in said sustain discharge of said plasma display panel.

6. The plasma display device according to claim 1, wherein when said power module is used to display an image, a temperature increase saturation temperature of said power module is calculated using a coefficient stored in advance in a storage device from said temperature information, and said calculated temperature increase saturation temperature of said power module is compared with a predetermined temperature,
whereby, when said temperature increase saturation temperature of said power module is lower than said predetermined temperature, the temperature of said power module is detected by said temperature detecting unit, and
when said temperature increase saturation temperature of said power module is equal to or greater than said predetermined temperature, image quality adjustment is performed by reducing a number of sustain pulses in said sustain discharge of said plasma display panel.

7. The plasma display device according to claim 1, wherein said temperature information detected by said temperature detecting unit is a voltage.

8. The plasma display device according to claim 5, wherein said predetermined temperature is a solder surface prescribed temperature value.

9. The plasma display device according to claim 1, wherein said input signal control unit control a number of pulses in said sustain discharge of said plasma display panel in accordance with said temperature information.

10. The plasma display device according to claim 1, wherein said input signal control unit control a voltage level of said sustain discharge of said plasma display panel in accordance with said temperature information.

11. The plasma display device according to claim 1, wherein said input signal control unit control a magnitude of a power source current used in said sustain discharge of said plasma display panel in accordance with said temperature information.

12. The plasma display device according to claim 1, wherein said power module is disposed in a perpendicular direction to the ground, and said temperature detecting unit are disposed in an upper portion of said power module.

13. The plasma display device according to claim 12, wherein said power module is provided in a plurality, and said temperature detecting unit are disposed in the respective upper portions of said power modules.

14. The plasma display device according to claim 12, wherein said power module is provided in a plurality, and said temperature detecting unit is disposed in the upper portion of said power module disposed in the uppermost position.

15. A power module which drives a plasma display panel in accordance with a signal from input signal control unit, comprising:
a plurality of power devices for generating a drive signal for said plasma display panel; and
temperature detecting unit which detects the temperature of said power module,
wherein the temperature of said power module is controlled by feeding temperature information detected by said temperature detecting unit back to said input signal control unit.

16. The power module according to claim 15, wherein when said power module temperature reaches or exceeds a predetermined value following feedback of said temperature information detected by said temperature detecting unit to said input signal control unit, the output of said power module is blocked.

17. The power module according to claim 15, wherein said temperature information detected by said temperature detecting unit is fed back to said input signal control unit, when said power module temperature exceeds a predetermined value, control is performed to hold said power module temperature at a fixed value, and when this condition remains unchanged for a predetermined time period, the output of said power module is blocked, thereby entering a low power consumption mode.

18. The power module according to claim 15, wherein said power module is used to perform a sustain discharge on said plasma display panel.

19. The power module according to claim 15, wherein said temperature detecting unit comprise a temperature detection element provided in the vicinity of said power devices, and a temperature detection circuit, connected to said temperature detection element, for outputting the temperature information that corresponds to the output of said temperature detection element.

20. The power module according to claim 15, wherein said temperature detecting unit comprise a temperature detection element provided in the vicinity of said power devices,
said temperature detection element is connected to a temperature detection circuit provided on the exterior of said power module, and
said temperature detection circuit outputs the temperature information that corresponds to the output of said temperature detection element.

21. The power module according to claim 20, wherein said temperature detection element is a thermistor, and said temperature detection circuit outputs said temperature information on the basis of a resistance characteristic of said thermistor.

22. The power module according to claim 20, wherein said temperature detection element is a diode, and said temperature detection circuit outputs said temperature information on the basis of a forward direction voltage characteristic of said diode.

23. The power module according to claim 20, wherein said temperature detection element is a thermoelectric couple, and said temperature detection circuit outputs said temperature information on the basis of a voltage characteristic of said thermocouple.
